(19) United States
(12) Patent Application Publication
(10) Pub. No.: US 2021/0054874 A1
(43) Pub. Date: Feb. 25, 2021

(54) BUSHING ASSEMBLY

(71) Applicant: Rapid Race Cars, Inc., Angola, IN (US)

(72) Inventors: Lawrence R. Marckel, JR., Angola, IN (US); Ronda Marckel, Angola, IN (US); Troy L. Duncan, Angola, IN (US)

(73) Assignee: Rapid Race Cars, Inc., Angola, IN (US)

(21) Appl. No.: 16/989,352

(22) Filed: Aug. 10, 2020

Related U.S. Application Data
(60) Provisional application No. 62/889,256, filed on Aug. 20, 2019.

(51) Int. Cl. F16C 17/02; F16C 33/06; B23Q 5/04

(52) U.S. Cl. CPC F16C 17/02; F16C 2322/00; B23Q 5/04; F16C 33/06

(57) ABSTRACT

A cutting machine for machining a bar stock that includes at least one cutting tool, a headstock, and a bushing assembly connected to the headstock. The bushing assembly includes a guide member that includes a body having at least one bore therein and at least one guide mating feature. The bushing assembly further includes a sleeve removably inserted within the at least one bore of the body of the guide member. The sleeve includes a body having a bore therein and at least one sleeve mating feature. The bore of the sleeve is configured for supporting and holding the bar stock. The at least one sleeve mating feature is engaged with the at least one guide mating feature for retaining the sleeve within the guide member.

### CROSS REFERENCE TO RELATED APPLICATIONS

This is a non-provisional application based upon U.S. provisional patent application Ser. No. 62/889,256, entitled “GUIDE BUSHING SLEEVE”, filed Aug. 20, 2019, which is incorporated herein by reference.

### BACKGROUND OF THE INVENTION

### 1. Field of the Invention

The present invention relates to cutting machines, and, more particularly, to a bushing assembly for a cutting machine.

### 2. Description of the Related Art

Swiss machining refers to the use of machines that use bar stock of specific dimensions that is fed through a headstock to effectively repeatably manufacture parts from the bar stock. These Swiss machines typically are 3-9 axis multi-axis Computer Numerical Control (CNC) machines that combine CNC machines with Autoloaders, CNC swiss screw machines, and Twin Spindle lathes. The Swiss machining process uses an assortment of shaping tools and spindles that enable operators to carry out a number of different procedures.

For manufacturing purposes, multi-tasking machines provide far greater flexibility than standard lathes and milling units. For example, a Swiss-type lathe is a variety of a turning machine that feeds the stock through a guide bushing. This means the outside diameter (OD) turning tool can always cut the stock near the bushing, and therefore near the point of support, no matter how long the workpiece. The machine feeds the work out of the spindle and past the tool as it goes. This makes the CNC Swiss-type particularly effective for long and slender turned parts.

Typically, a bushing or a collet is used to hold the bar stock in position within the Swiss-type lathe. The bushing has a bore with a set diameter that is selected to allow the OD of the stock to feed therethrough. Since the diameter of the bushing directly corresponds the diameter of the bar stock, the bushing which holds the bar stock must generally also be changed when changing the size, i.e., diameter, of the bar stock. The process of changing bushings can be costly and time-consuming. Also, a user of a CNC machine may experience delays in manufacturing because the user may need to order a unique bushing from a tool supplier in order to machine a correspondingly sized bar stock. Additionally, the bore of the bushing has a set length which provides support for the bar stock, which may not be equal to the overall length of the bushing. Often, due to the structural connection between the bushing and the headstock, the bushing may not be capable of supporting the bar stock along its entire length. In such cases, the ability of the bushing to support the bar stock may limit the seamless or uninterrupted work area of the bar stock. Therewith, the bushing may restrict the level of complexity of a given machining process.

What is needed in the art is a cost-effective bushing assembly that accommodates variously sized bar stocks while also allowing for a greater complexity in the design of the component being produced from a given bar stock.

### SUMMARY OF THE INVENTION

The present invention provides a bushing assembly that generally includes a guide member, such as a collet or bushing, and a guide-bushing sleeve that is positioned within the guide member for supporting and holding a bar stock. The guide member includes a body, which has at least one bore therein, and at least one guide mating feature. The sleeve includes a body, which has a bore therein, and at least one sleeve mating feature. The at least one sleeve mating feature is engageable with the at least one guide mating feature for retaining the sleeve within the guide member.

The invention in one form is directed to a cutting machine for machining a bar stock. The cutting machine includes at least one cutting tool, a headstock, and a bushing assembly connected to the headstock. The bushing assembly includes a guide member with a body having at least one bore therein and at least one guide mating feature. The bushing assembly further includes a sleeve removably inserted within the at least one bore of the body of the guide member. The sleeve includes a body having a bore therein and at least one sleeve mating feature. The bore of the sleeve is configured for supporting and holding the bar stock. The at least one sleeve mating feature is engaged with the at least one guide mating feature for retaining the sleeve within the guide member.

The invention in another form is directed to a bushing assembly. The bushing assembly includes a guide member that includes a body having at least one bore therein and at least one guide mating feature. The bushing assembly further includes a sleeve removably inserted within the at least one bore of the body of the guide member. The sleeve includes a body having a bore therein and at least one sleeve mating feature. The bore of the sleeve is configured for supporting and holding the bar stock. The at least one sleeve mating feature is engaged with the at least one guide mating feature for retaining the sleeve within the guide member.

An advantage of the present invention is that the sleeve of the bushing assembly is easily insertable and removable from the guide member which accordingly allows a user to easily and efficiently change bar stocks.

Another advantage of the present invention is that the sleeve of the bushing assembly increases a support area of the bushing assembly which in turn increases the effective work area on the bar without interrupting a machining process to reposition the bar stock.

Yet another advantage of the present invention is that the sleeve of the bushing assembly allows a user to run a looser fit between the sleeve and bar stock in order to accommodate clearance difference among various bar stocks.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a Swiss machine according to the present invention;

FIG. 2 is an end view of a bushing assembly which includes a bushing and a sleeve according to the present invention;

FIG. 3 is an end view of the bushing of FIGS. 1-2;

FIG. 4 is a perspective view of the sleeve of FIGS. 1-2;

FIG. 5 is a perspective view of another embodiment of a sleeve according to the present invention;

FIG. 6 is a perspective view of another embodiment of a sleeve according to the present invention;

FIG. 7 is an exploded view of another embodiment of a bushing assembly according to the present invention; and

FIG. 8 is a perspective view of another embodiment of a sleeve according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

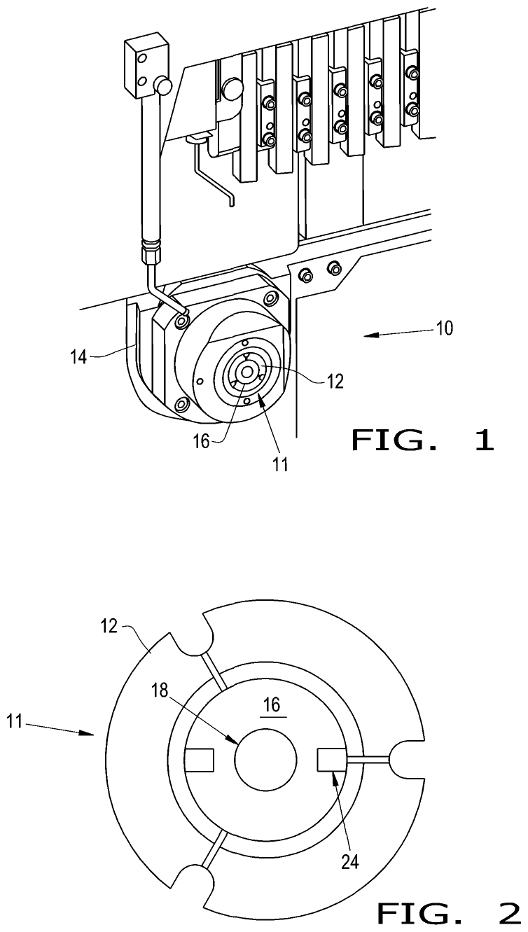

Referring now to the drawings, and more particularly to FIGS. 1-4, there is shown a cutting machine 10 in the form of a Swiss machine 10 that has a bushing assembly 11. The Swiss machine 10 also includes one or more cutting tools for machining the bar stock.

The bushing assembly 11 includes a guide member 12, which is arranged in a headstock 14 of the Swiss machine 10, and a sleeve 16, which is inserted into the guide member 12. The bushing assembly 11 is connected to the headstock 14 via the guide member 12 being arranged in the headstock 14. The bushing assembly 11 supports and holds the bar stock, which is fed through the sleeve 16.

The guide member 12 may be a collet or a bushing 12. The collet or bushing 12 may be referred to as alternates to one another herein. Even though bushings and collets are distinct from each other, for purposes of describing the invention, they serve the purpose of retaining the sleeve 16 therein through which bar stock is fed and supported.

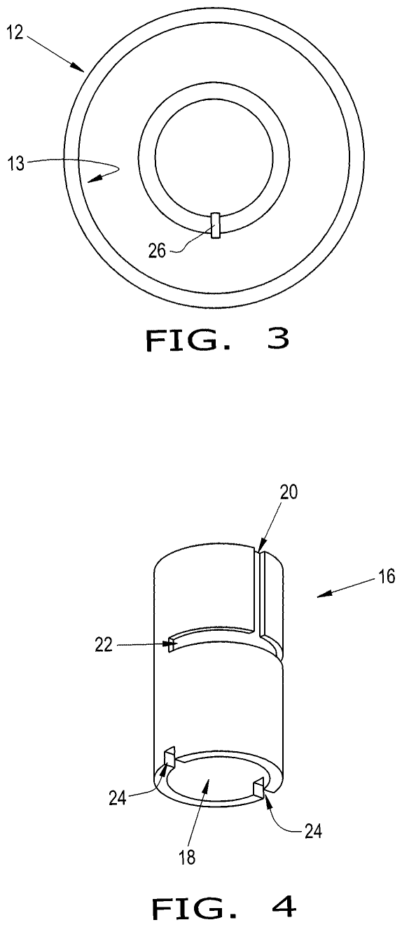

The guide member 12 may include a body, which has at least one bore 13 therein, and at least one guide mating feature 26 (FIG. 3). The guide member 12 may be of a standard size and the sleeve 16 can be positioned within guide member 12 so that a bar stock can be fed through the bore 18 of sleeve 16. The guide member 12 may comprise any desired size and material, such as metal.

The one or more guide mating features 26 of the guide member 12 may be located within the at least one bore 13 of the body of the guide member 12. The one or more guide mating features 26 can be in the form of one or more protrusions 26 that interact with corresponding sleeve mating feature(s) 20, 22 in the sleeve 16 for captivating sleeve 16 inside guide member 12 (FIGS. 3 and 4). Protrusion 26 may be movable to also act to secure sleeve 16 to guide member 12, in that protrusion 26 may be threaded and be manipulated to secure sleeve 16. Therein, protrusion 26 may also be in the form of a threaded member extending through a corresponding axial bore in guide member 12. Protrusion 26 can also be thought of as a securing means 26 that interacts with sleeve 16 to position and secure sleeve 16 to guide member 12.

Sleeve 16 is inserted within and retained in guide member 12. Sleeve 16 may include a body with the bore 18 therein and at least one sleeve mating feature 20, 22. The bore 18 supports and holds the bar stock. Sleeve 16 may have a longer support surface (the length of the cylindrical bore 18) than that afforded by guide member 12. In other words, the length of the sleeve 16 can be substantially equal, plus or minus one inch, to the length of the guide member 12 such that the bar stock is supported by the sleeve 16 substantially along the entire length of the guide member 12. For a given guide member, the sleeve 16 may increase the length of the support surface by 2-4 inches. The resulting increase in the support area provided by the sleeve 16 allows for an increased back draw of the bar stock, without concern of the bar stock falling out of the guide member 12. Thus, the sleeve 16 increases the effective work area on the bar stock for uninterrupted machining, e.g. threading of the bar stock. Therewith, the sleeve 16 also allows the bar stock to be machined into a more complex component during a given uninterrupted machining process. The sleeve 16 may comprise any desired size and material, such as metal.

The one or more sleeve mating features 20, 22 of the sleeve 16 can be located on the outer surface of the body of the sleeve 16. The one or more sleeve mating features 20, 22 and guide mating features 26 may engage with one another to prevent a movement of the sleeve 16 relative to the guide member 12. The at least one mating feature 20, 22 may include at least one groove 20, 22 which corresponds to and receives the guide mating feature(s) 26. For example, sleeve 16 may have two grooves 20, 22 in the form of an insertion groove 20 and a locking groove 22. The insertion groove 20 is parallel to the longitudinal axis of the bore 18, and the locking groove 22 is perpendicular to the insertion groove 20. The insertion groove 20 may extend from the edge of the sleeve 16 to a desired location further along the length of the sleeve, for example a middle portion of the sleeve 16. The locking groove 22 can interface with the insertion groove and extend in opposing directions therefrom. Hence, the resulting pathway created by the grooves 20, 22 may comprise an approximate “T”-shape. It should be appreciated that the grooves 20, 22 may have any desired cross-sectional shape and be angled relative to the longitudinal axis of the bore 18 in any desired orientation.

During assembly, the sleeve 16 can be inserted into the guide member 12 so that the groove 20 is indexed to the corresponding protrusion(s) 26 in the guide member 12. When the sleeve 16 is inserted sufficiently, then the sleeve 16 is rotated so that the protrusion then follows the locking groove 22 to hold the sleeve 16 in position in the guide member 12. Notches 24 are present on an end of the sleeve 16 so that the sleeve 16 can be easily rotated in the guide member 12, since the outer face of the sleeve 16 is substantially aligned with a face of the guide member 12. Thereby, the sleeve 16 may be easily inserted or removed as desired via simply rotating and sliding the sleeve 16 to lock or unlock the corresponding mating features 20, 22, 26 from one another.

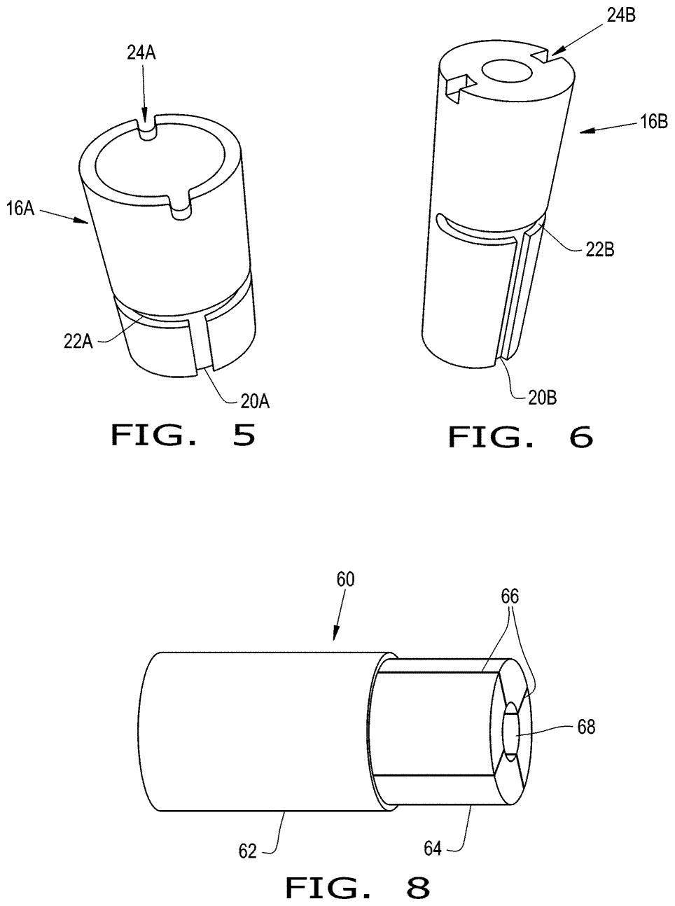

Referring now to FIGS. 5 and 6, there are illustrated two sleeves 16 here referred to as 16A and 16B, with the A and B suffixes being added to illustrate differences in geometry, and the numbers correspond to the features discussed above. Sleeve 16B is longer than sleeve 16A to illustrate that the present invention can be used to extend the supporting surface to be greater than that of the guide member 12 in which the sleeve 16 is captively held.

Advantageously, the sleeves 16, 16A, 16B of the present invention each allow for quick changes into and out of the guide member 12, so that differing sizes of bar stock can be easily used. The sleeves 16, 16A, 16B also allow flexibility in how the bar stock is supported and over a selected longitudinal length of the bar stock. Another great advantage is the ease in making a sleeve 16, 16A, 16B in order to accommodate variously sized bar stocks rather than waiting for an entirely new and unique guide member 12 from a tool supplier to arrive. Yet another advantage is that the additional support provided by each sleeve 16, 16A, 16B allows a user to run a looser fit on the bar stock. In other words, each sleeve 16, 16A, 16B accommodates variances in sizing, e.g. tolerance differences, among differing bar stocks.

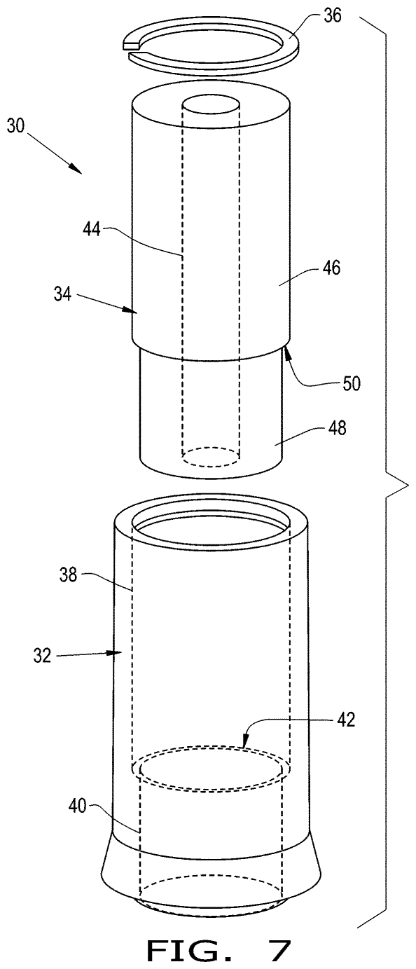

Referring now to FIG. 7, there is shown another embodiment of a bushing assembly 30 according to the present invention. The bushing assembly 30 generally includes a guide member 32, a sleeve 34, and a retaining member 36.

The guide member 32 may be substantially similar to the guide member 12, as described above, except that the body of the guide member 32 includes two or more bores 38, 40 with differing diameters. The guide member 32 also includes a guide mating feature 42 in the form of an inner mating surface 42 located in between the bores 38, 40. In other words, since the bores 38, 40 are directly adjacent to one another and differ in size, an edge or mating surface 42 is formed at the juncture of the bores 38, 40.

The sleeve 34 may be substantially similar to the sleeve 16, as described above, except that the body of the sleeve 34 has one bore 44 and two portions 46, 48 of differing diameters. The portions 46, 48 respectively correspond to the bores 38, 40. The sleeve 34 also has a sleeve mating feature 50 in the form of an outer mating surface 50 located in between the portions 46, 48.

The retaining member 36 is connected in between the guide member 32 and the sleeve 34. The retaining member 36 prevents an outward axial movement of the sleeve 34 relative to the guide member 32. The retaining member 36 can be in the form of a retaining ring, such as a snap ring 36, that fits within a corresponding groove 52 in the bore 38 of the guide member 32.

During assembly, the sleeve 34 may be inserted into the guide member 32. The sleeve 34 will slide into the guide member 32 until the axial edges or mating surfaces 42, 50 contact one another and accordingly prevent a movement of the sleeve 34 relative to the guide member 32 in an inward axial direction. Thereafter, the retaining member 36 may be inserted into the groove 52 in the bore 38, which in turn prevents the sleeve 34 from moving outwardly in an outward axial direction, thus retaining the sleeve 34 within the guide member 32. Thereby, the sleeve 34 may be easily inserted or removed as desired via simply inserting or removing the retaining member 36. Thus, the bushing assembly 30 offers the same advantages of the bushing assembly 11.

Referring now to FIG. 8, there is shown another embodiment of a sleeve 60 in the form of a tension adjustable sleeve 60. The sleeve 60 may be substantially similar to the sleeve 34, as described above, except that one of the portions 62, 64 of the sleeve 60 has at least one slit or cut 66 extending through the depth of the sleeve 60. The one or more slits 66 may extend parallel to the longitudinal axis of the bore 68. The one or more slits 66 allow the smaller portion 64 of the sleeve 60 to flex. In turn, the flexing of the smaller portion 64 adjusts, for example increases or decreases, the diameter of the bore 68 in order to adjust the gripping force which the sleeve 60 applies onto the bar stock.

It is noted that each sleeve 16, 16A, 16B, 34, 60 may also be additionally held within a respective guide member 12, 32 by the clamping force of the guide member 12, 32. After inserting the sleeve 16, 16A, 16B, 34, 60 within the guide member 12, 32, an adjustment device of the guide member 12, 32 may be tightened so that the guide member 12, 32 applies a clamping force onto the sleeve 16, 16A, 16B, 34, 60. This clamping force, acting alone or in combination with the mating features 20, 22, 26, 42, 50, may retain the sleeve 16, 16A, 16B, 34, 60 within the guide member 12, 32. As can be appreciated, the adjustment device of the guide member 12, 32 may be loosened so that the sleeve 16, 16A, 16B, 34, 60 may be removed from the guide member 12, 32. The adjustment device of the guide member 12, 32 may be in the form of an adjustable clamping nut.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A cutting machine for machining a bar stock, comprising:
at least one cutting tool;
a headstock; and
a bushing assembly connected to the headstock, the bushing assembly comprising:
a guide member including a body having at least one bore therein and at least one guide mating feature; and
a sleeve removably inserted within the at least one bore of the body of the guide member, the sleeve including a body having a bore therein and at least one sleeve mating feature, the bore of the sleeve being configured for supporting and holding the bar stock, the at least one sleeve mating feature being engaged with the at least one guide mating feature for retaining the sleeve within the guide member.

2. The cutting machine of claim 1, wherein the guide member has a length, wherein the sleeve has a length which is substantially equal to the length of the guide member such that the bar stock is supported by the sleeve substantially along the length of the guide member.

3. The cutting machine of claim 1, wherein the at least one guide mating feature is located within the at least one bore of the body of the guide member.

4. The cutting machine of claim 1, wherein the body of the sleeve includes an outer surface, wherein the at least one sleeve mating feature is located on the outer surface of the body of the sleeve such that the at least one sleeve mating feature and the at least one guide mating feature engage with one another for preventing a movement of the sleeve relative to the guide member.

5. The cutting machine of claim 1, wherein the at least one guide mating feature is in the form of a protrusion.

6. The cutting machine of claim 5, wherein the at least one sleeve mating feature is in the form of at least one groove which receives the protrusion.

7. The cutting machine of claim 1, wherein the at least one bore of the body of the guide member includes a first bore having a first diameter and a second bore having a second diameter which is different than the first diameter, wherein the at least one guide mating feature is in the form of an inner mating surface located in between the first bore and the second bore.

8. The cutting machine of claim 7, wherein the body of the sleeve has a first portion and a second portion which respectively correspond to the first bore and the second bore of the body of the guide member, wherein the at least one sleeve mating feature is in the form of an outer mating surface located in between the first portion and the second portion, the outer mating surface contacting the inner mating surface for preventing a movement of the sleeve relative to the guide member.

9. The cutting machine of claim 1, wherein the bushing assembly further comprises a retaining member connected in between the guide member and the sleeve, the retaining member being configured for preventing an axial movement of the sleeve relative to the guide member.

10. The cutting machine of claim 1, wherein the sleeve includes at least one slit such that the sleeve can vary an amount of a gripping force which is applied by the sleeve onto the bar stock.

11. A bushing assembly, comprising:
a guide member including a body having at least one bore therein and at least one guide mating feature; and
a sleeve removably inserted within the at least one bore of the body of the guide member, the sleeve including a body having a bore therein and at least one sleeve mating feature, the bore of the sleeve being configured for supporting and holding a bar stock, the at least one sleeve mating feature being engaged with the at least one guide mating feature for retaining the sleeve within the guide member.

12. The bushing assembly of claim 11, wherein the guide member has a length, wherein the sleeve has a length which is substantially equal to the length of the guide member such that the bar stock is supported by the sleeve substantially along the length of the guide member.

13. The bushing assembly of claim 11, wherein the at least one guide mating feature is located within the at least one bore of the body of the guide member.

14. The bushing assembly of claim 11, wherein the body of the sleeve includes an outer surface, wherein the at least one sleeve mating feature is located on the outer surface of the body of the sleeve such that the at least one sleeve mating feature and the at least one guide mating feature engage with one another for preventing a movement of the sleeve relative to the guide member.

15. The bushing assembly of claim 11, wherein the at least one guide mating feature is in the form of a protrusion.

16. The bushing assembly of claim 15, wherein the at least one sleeve mating feature is in the form of at least one groove which receives the protrusion.

17. The bushing assembly of claim 11, wherein the at least one bore of the body of the guide member includes a first bore having a first diameter and a second bore having a second diameter which is different than the first diameter, wherein the at least one guide mating feature is in the form of an inner mating surface located in between the first bore and the second bore.

18. The bushing assembly of claim 17, wherein the body of the sleeve has a first portion and a second portion which respectively correspond to the first bore and the second bore of the body of the guide member, wherein the at least one sleeve mating feature is in the form of an outer mating surface located in between the first portion and the second portion, the outer mating surface contacting the inner mating surface for preventing a movement of the sleeve relative to the guide member.

19. The bushing assembly of claim 11, further comprising a retaining member connected in between the guide member and the sleeve, the retaining member being configured for preventing an axial movement of the sleeve relative to the guide member.

20. The bushing assembly of claim 11, wherein the sleeve includes at least one slit such that the sleeve can vary an amount of a gripping force which is applied by the sleeve onto the bar stock.
